(19) United States
(12) Patent Application Publication
(10) Pub. No.: US 2023/0134140 A1
(43) Pub. Date: May 4, 2023

(54) Backup Vehicle Battery

(71) Applicant: Robert Williams, Burch Run, MI (US)

(72) Inventor: Robert Williams, Burch Run, MI (US)

(21) Appl. No.: 18/052,881

(22) Filed: Nov. 4, 2022

Related U.S. Application Data
(60) Provisional application No. 63/275,818, filed on Nov. 4, 2021.

(51) Int. Cl. B60L 53/80; B60L 58/24

(52) U.S. Cl. CPC B60L 53/80; B60L 58/24

(57) ABSTRACT

A charging port adapted for secure placement in a vehicle that enables a removable battery to provide power to the vehicle and when the vehicle is in a normal operation mode, charge the removable battery.

### BACKGROUND OF THE INVENTION

### 1. Field of the Invention

This invention generally relates to vehicle power systems and, more particularly, to vehicle batteries.

### 2. Related Applications

This application claims priority to U.S. Provisional application 63/275,818, filed on Nov. 4, 2021, titled Backup Vehicle Battery, and is incorporated by reference herein.

### RELATED ART

A problem exists that fossil fuel vehicles require a battery to start their engines. At times the battery runs down or fails to charge to a level to start an engine adequately. What often occurs is the owner of the vehicle must open the hood and have jumper cables available to “jump” start the car. Another problem that can also happen is that a contractor with battery-operated tools is at an off-grid job site and needs to charge the batteries for his tools.

Therefore, there is a need in the art for an approach to start a vehicle and charge removable batteries.

### SUMMARY

Systems and methods consistent with the present invention provide an approach for “jumping” a vehicle to get it started without opening the hood or even exiting the vehicle using a removable rechargeable battery. Further, that battery may be recharged while the vehicle is operating. This approach is described using a fossil fuel vehicle. Still, it may also be used to temporarily power an electric vehicle to enable it to work long enough to get to a charging station or a safe stopping location and call for further aid.

Other methods, features, and advantages of the invention will become apparent to one with skill in the art upon examination of the following figures and detailed description. It is intended that all such additional methods, features, and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a diagram 100 of a removable rechargeable battery 102 in accordance with an example implementation of the invention.

FIG. 2 is a diagram 200 of a battery port 202 for securing the rechargeable battery 102 of FIG. 1 in accordance with an example implementation of the invention.

FIG. 3 is a block diagram 300 of the port 202 of FIG. 2 in accordance with an example implementation of the invention.

### DETAILED DESCRIPTION

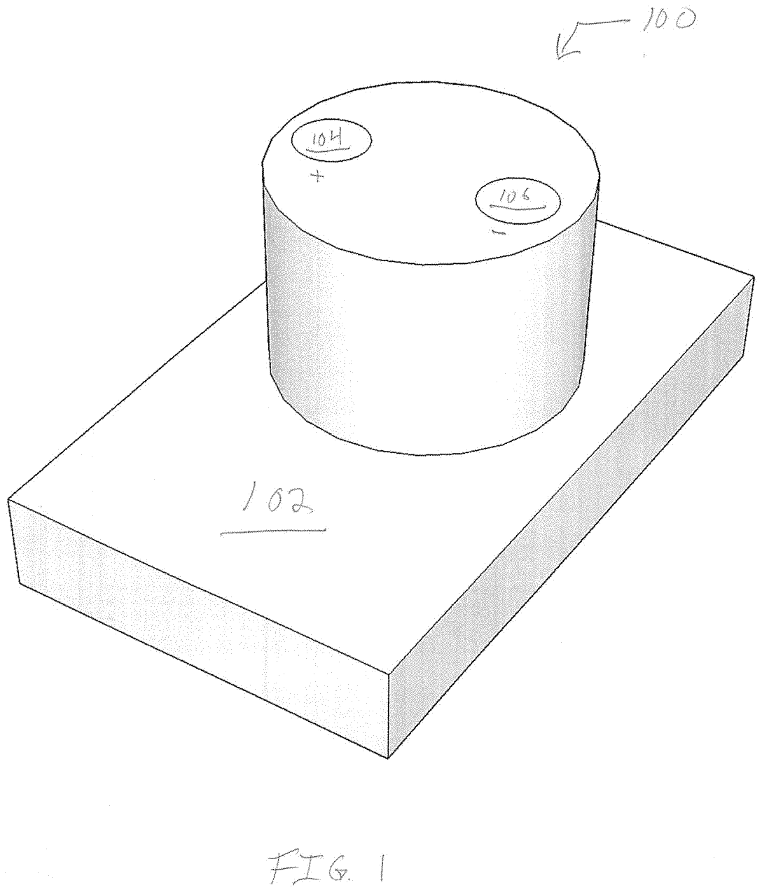

In FIG. 1, a diagram 100 of a removable rechargeable battery (RRB) 102 is depicted in accordance with an example implementation of the invention. The RRB 102 is typically a dry cell battery with a plastic enclosure with a plurality of cells grouped to achieve a predetermined voltage and amperage. The cells may be zinc—carbon battery, nickel—cadmium battery (Ni—Cd battery or NiCad battery), alkaline battery (zinc metal and manganese dioxideor), or lithium-ion battery (Li-ion battery), to give but a few examples. The typical voltage for removable batteries is 12V, 18V, or 40V. Other types of cells, such as wet or fuel cells, may be used in other implementations. The RBB 102 has a plurality of contacts that include at least a positive contact 104 and negative contact 106.

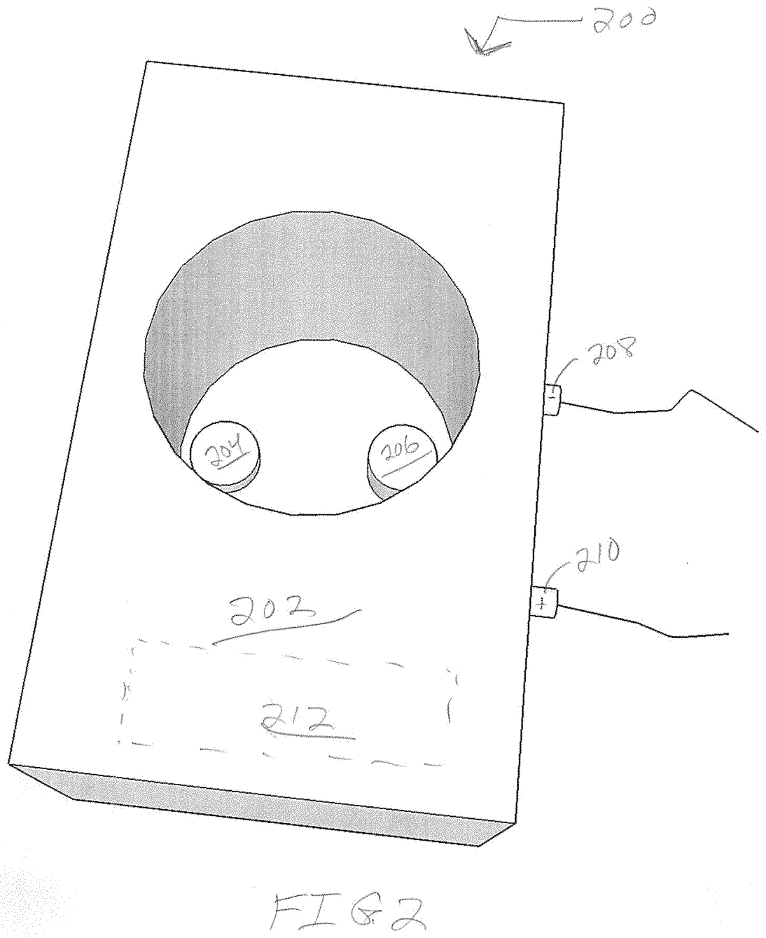

FIG. 2 is a diagram 200 of a battery port 202 for securing the rechargeable battery 102 of FIG. 1 in accordance with an example implementation of the invention. The battery port 202 is able to secure the RRB 102, such that the RRB's positive contact 104 contacts the battery port positive contact 204 and the RRB's negative contact contacts the battery port negative contact 206. The battery port in the current implementation is made out of plastic, but in other implementations, it may be made out of metal, wood, resin, or a combination of any of plastic, metal, wood, and resin. The battery port 202 also includes circuitry 212 that enables the safe and efficient operation of the battery port 202 when charging the battery 102 or providing power to the vehicle via negative lead 208 and positive lead 210.

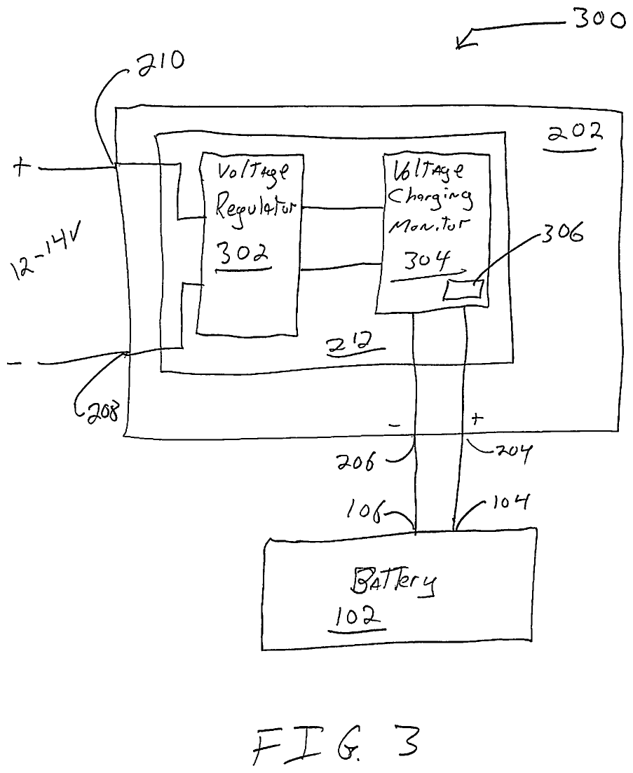

FIG. 3 is a block diagram 300 of the circuitry 212 port 202 of FIG. 2 in accordance with an example implementation of the invention. The battery 102 connects with the battery port 202 with battery positive contact 104 and negative contact 106 contacting battery port positive contact 204 and battery port negative contact 206 respectively. The negative lead 208 and positive lead 210 are coupled to the battery of a vehicle. The negative lead 208 and positive lead 210 connect with a voltage regulator 302 in the battery port 202 that regulates the voltage between the vehicle and battery 102. A vehicle battery is typically between 12-14 volts, and the battery 102 is an 18-volt battery in this example, but in other implementations, other voltages may be used, such as 12, 20, and 40 volts. The voltage regulator 302 is coupled to a voltage charge monitor 304. The voltage charge monitor 304 monitors the condition of the battery 102. When the battery port 202 operates in a “charging” mode, the voltage charge monitor 302 charges the battery to a predetermined point of 80% and then trickle charges to a full charge. The voltage charge monitor 302 may also monitor the temperature of the charging port 202 and the battery 102 with sensors 306, such as electronic temperature probes. In the charging mode, voltage moves from the vehicle to the battery 102. In the “powering” mode, battery 102 provides power via the battery port 202 to the vehicle. When in the “powering” mode, the voltage charging monitor 304 still monitors the condition of the battery 102, such as temperature. The change between the “charging” mode and “powering” mode is controlled and detected by the voltage regulator 302 in the current implementation. The voltage regulator can detect if the external voltage of the vehicle is below a predetermined level, such as 12 volts.

If a vehicle has a “dead” battery, a battery 102 may be placed in battery port 202, and the battery port 202 will automatically determine that the battery port should operate in the “powering” mode and provide voltage and current at the battery port leads 208 and 210. The current from battery 102 controlled by the voltage regulator 302 enables the vehicle's starter to turn and start. Once the vehicle has been started, the alternator creates a voltage and current that is detectable on the battery port leads 208 and 210 and causes the voltage regulator 302 to switch to the “charging” mode to charge the battery 102.

The battery port 202 is preferably mounted in the interior of the vehicle. The advantage of such place and mounting is a person can place and remove the battery 102 without the risk of being outside of their vehicle where they would be subject to weather, crime, and other vehicles. Another advantage of the battery port 202 is that while a person is driving to a job site, they can charge their battery 102, which may be used in a battery-operated tool. In other implementations, the battery port may accept a plurality of batteries and/or types of batteries. Yet another advantage is the battery 102 may be brought inside with a person and kept warm on cold days and provide the voltage and current to their vehicle when their vehicle battery is adversely affected by the cold.

In some implementations, the battery port may also have a receptacle that enables current flow from battery 102 through the battery port to the receptacle. A cable that functions as a jumper cable may be coupled to the receptacle and connected to another vehicle. The connection to the other vehicle may be via a direct connection to the other vehicle's battery or a connection to what is commonly referred to as a cigarette lighter. Typically, the cable will be able to handle 12 volts at high amperage.

The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A battery port, comprising:
a housing having a positive lead and a negative lead;
a voltage regulator coupled to the negative lead and the positive lead;
a voltage monitor coupled to the voltage regulator; and
at least a positive contact and a negative contact adapted for coupling with a removable battery.

2. The battery port of claim 1, wherein the voltage regulator regulates 18 volts to 12 volts.

3. The battery port of claim 1, wherein the voltage regulator regulates 40 volts to 12 volts.

4. The battery port of claim 1, is adapted for coupling with a removable battery, wherein the battery port is adapted for coupling with a power tool removable battery.

5. The battery port of claim 1, wherein the voltage monitor includes a monitor for temperature.

6. The battery port of claim 1, wherein the voltage monitor switches between charging and discharging the removable battery.

7. The battery port of claim 1 is located in the cabin of a vehicle.
